(19) United States
(12) Patent Application Publication
(10) Pub. No.: US 2010/0145998 A1
(43) Pub. Date: Jun. 10, 2010

(54) DYNAMIC INTERACTIVE PERSONAL INFORMATION AND RATING SYSTEM

(76) Inventor: Stephany Poce, Salt Lake City, UT (US)

Correspondence Address: WESLEY M. LANG, P.O. BOX 1909, SANDY, UT, 84091, US

(21) Appl. No.: 12/572,970

(22) Filed: Oct. 2, 2009

Related U.S. Application Data
(60) Provisional application No. 61/102,280, filed on Oct. 2, 2008.

(51) Int. Cl. G06F 17/30

(52) U.S. Cl. 707/784; 707/E17.059

(57) ABSTRACT

A dynamic personal rating system is disclosed for soliciting, collecting, managing, summarizing, reviewing, censoring, indexing, linking, and displaying information regarding individuals.

### CROSS-REFERENCE TO RELATED APPLICATIONS

This application claims the benefit of U.S. Provisional Application No. 61/102,280, filed Oct. 2, 2008, which is hereby incorporated by reference herein in its entirety, including but not limited to those portions that specifically appear hereinafter, the incorporation by reference being made with the following exception: In the event that any portion of the above-referenced application is inconsistent with this application, this application supercedes said above-referenced application.

### STATEMENT REGARDING FEDERALLY SPONSORED RESEARCH OR DEVELOPMENT

Not applicable.

### BACKGROUND OF THE INVENTION

This invention relates to a dynamic personal rating system. More particularly, this invention relates to a dynamic personal rating system for soliciting, collecting, managing, summarizing, reviewing, censoring, indexing, linking, and displaying information regarding individuals.

Today's dating and relationship environment presents many challenges in terms of random chance, danger, difficulty presented by the necessity of meeting and interacting with individuals about one whom generally knows little or nothing. All too frequently, information material to analyzing an individual's personality, good or bad, are not learned until after a relationship has been established and progressed to a certain stage. While this problem has always been inherent in the dating and relationship environment, with the internet making possible interactive database management tools, this problem can be alleviated by providing a platform for users to submit information regarding individuals that can be organized in meaningful categories and made accessible for other's to view in order to obtain information on selected individuals prior to a relationship.

Thus, it would be useful to utilize the internet to provide a dynamic personal rating system regarding individuals. It would also be useful if the dynamic personal rating system permitted use of multiple languages.

It would also be useful if the dynamic personal rating system contained an interactive feature in which a user could pose questions via a chat room, private and anonymous messaging or other format and receive information directly from another user.

It would also be useful if the dynamic personal rating system allowed for data and information to be uploaded in video format.

It would also be useful if the dynamic personal rating that allowed for censorship of submitted data according to a predetermined set of parameters.

It would also be useful if the dynamic personal rating system further comprised a workstation function interface coupled to the central server database for converting and consolidating data into usable format. It would be still further useful if the dynamic personal rating system further comprised a plurality of interactive self-service internet terminals and central servers configured for accepting data from a plurality of contributors and displaying such data to a plurality of users and was further configured for internet transactions to allow updates and review by a plurality of persons and wherein the author can edit or delete his or her entries.

It would also be useful if the central server database comprised a structure for storing one or more data items selected from the group consisting of basic identifying data, explanatory text, biographical text, audio, source references, photographs, still images, video and other moving images.

It would also be useful if the dynamic personal rating system comprised a program and data structure configured for storing differentiating or cross referencing via age, height, weight, hair color, eye color and other physical identifying characteristics of the individual along with still or video images of the individual and

It would also be useful if the dynamic personal rating system further comprised a program and data structure for storing and processing data in a plurality of languages using the language and characters of original records with transliteration and translation to English.

It would also be useful if the dynamic personal rating system further comprised a program and data structure configured for permitting data submissions by a user to be stored independent of submissions by other users while being available for integration with other data submissions through a separate system of linking names that is accessible to such other users.

It would also be useful if the dynamic personal rating system further comprised a mechanism configured for allowing an authorized person to examine the database for assessing appropriateness of submission to the database.

It would also be useful if the dynamic personal rating system were capable of being integrated with dating databases and if the combined databases could be searchable by names, which are cross referenced with aliases, screen names, etc.

### BRIEF SUMMARY OF THE INVENTION

It is an object of the present invention to provide a dynamic personal rating system regarding individuals.

It is also an object of the invention to provide a dynamic personal rating system that permits use of multiple languages.

It is also an object of the invention to provide an interactive feature in which a user could pose questions via a chat room or other format and receive information directly from another user.

It is yet another object of the invention to provide a dynamic personal rating that allows for data and information to be uploaded in video format.

It is yet another object of the invention to provide a dynamic personal rating that allows for censorship of submitted data according to a predetermined set of parameters.

These and other objects can be addressed by providing a dynamic personal rating system for collecting, summarizing, indexing, individual identifier linked form, and displaying the information on a computer comprising:

(a) a central server database comprising
(i) a plurality of contributors' data spaces for storing personality data in individual-identifier linked form,
(ii) a submission link space coupled to the plurality of contributors' data spaces for making and storing links between personality items in each of the plurality of contributors' data spaces, and
(iii) a third-party link space coupled to the plurality of contributors' data spaces for making and storing links between personality items between the plurality of contributors' data spaces;

(b) a normal text and graphics interface coupled to the central server database;

(c) a basic data display coupled to the normal text and graphics interface;

(d) a data status and management mechanism coupled to the normal text and graphics interface for monitoring quantity and quality of data;

(e) a manual keying interface coupled to the central server database for inputting and correction of data; and

(f) a data conversion and automated input coupled to the central server database for converting data into usable format and inputting large data files.

In an embodiment of the invention, the dynamic personal rating system further comprises a workstation functions interface coupled to the central server database for converting and consolidating data into usable format. Still further, the dynamic personal rating system comprises a plurality of interactive self-service internet terminals and central servers configured for accepting data from a plurality of contributors and displaying such data to a plurality of users. Preferably, the dynamic personal rating system is configured for internet transactions to allow updates and review by a plurality of persons. The central server database may comprise a structure for storing one or more data items selected from the group consisting of basic identifying data, explanatory text, biographical text, source references, photographs, images, video and moving images.

Still further, the dynamic personal rating system preferably further comprises a program and data structure configured for storing age, height, weight, hair color, eye color and other physical identifying characteristics of an individual as well as images and videos of individuals.

In till another embodiment, the dynamic personal rating system further comprises a program and data structure for storing and processing data in a plurality of languages using the language and characters of original records with transliteration and translation to English.

The dynamic personal rating system further comprises a program and data structure configured for permitting data submissions by a user to be stored independent of submissions by other users while being available for integration with other data submissions through a separate system of linking names that is accessible to such other users. Further, the dynamic personal rating system comprises a program and data structure for allowing a selected person to link names within or between one or more other user's submissions without changing the underlying data.

In another embodiment, the dynamic personal rating system contained an interactive feature in which a user could pose questions via a chat room or other format and receive information directly from another user.

Moreover, the dynamic personal rating system further comprises a read-only virtual reality user interface configured for permitting a user or group of users to receive immediate visual and aural access to the data in the database, wherein the data appear as objects in a three-dimensional world with which the user can interact. Still further, the dynamic personal rating system further comprises a virtual reality user interface configured for permitting a user or group of users to receive immediate visual and aural access to the data in the database, wherein the data appear as objects in a three-dimensional world with which the user can interact, and whereby an authorized user can modify the database.

Another embodiment of the dynamic personal rating system further comprises a mechanism configured for allowing an authorized person to examine the database and submissions to the database for assessing appropriateness of submission to the database.

### BRIEF DESCRIPTION OF THE SEVERAL VIEWS OF THE DRAWINGS

FIG. 1 shows a block diagram of the dynamic personal rating system according to the present invention, including data sources, the main server database, and output options.

### DETAILED DESCRIPTION

Before the present dynamic personal rating system is disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise. Thus, for example, reference to a dynamic personal rating system containing “a program” includes reference to two or more of such programs, reference to “a data structure” includes reference to one or more of such data structures, and reference to “a central server database” includes reference to two or more of such central server databases.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

As used herein, a “publisher” or “contributor” is a person who submits data for inclusion in the dynamic personal rating system.

As used herein, a “user” or “searcher” is a person who obtains data from the dynamic personal rating system.

In its simplest, overview form, the system comprises a large Internet site connected intermittently to many thousands or even millions of PCs, located anywhere in the world, plus local and remote connections to a smaller number of large and powerful PCs, which are referred to here as data consolidation workstations.

The operating system can by any operating system known to the industry, such as Microsoft Windows NT Server. It should be noted that there are other operating systems that also accept Active Server Page (ASP) code, and the database type used is relational, of which there are several competing versions. The full production version of the system might use one or more of these differing system software components.

There are numerous HTML pages that contain menus of transactions, instructions on how to use the system, history of the project, and the like.

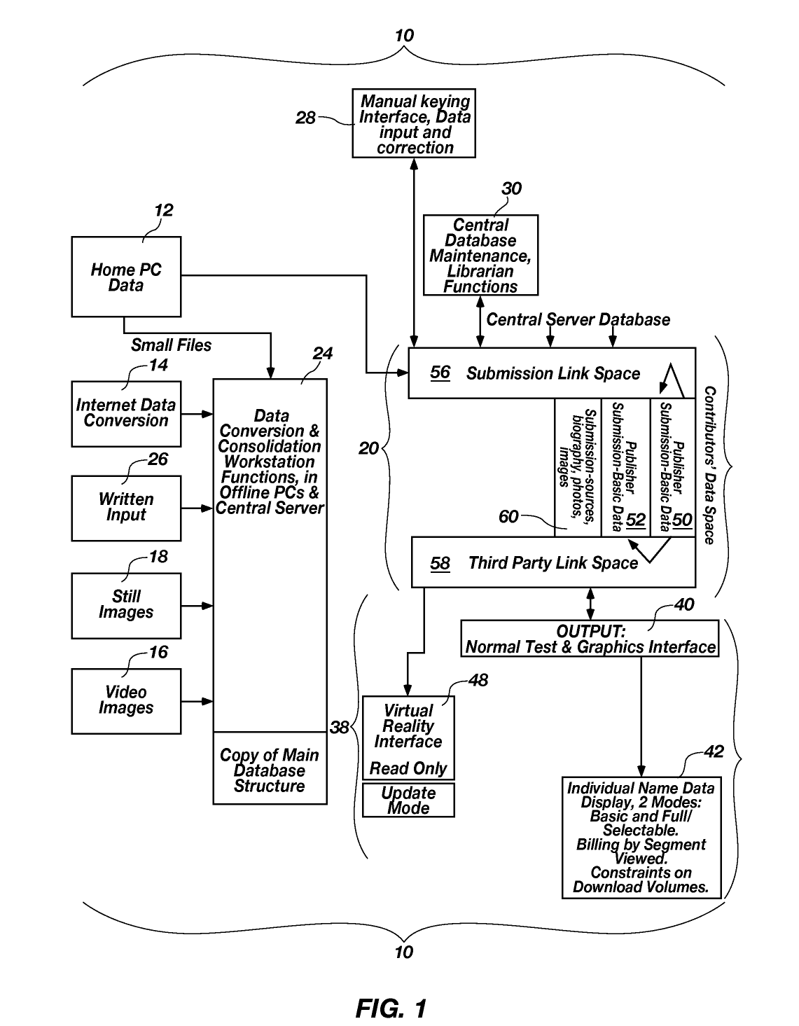

FIG. 1 shows a block diagram illustrating the major components of the dynamic personal rating system 10 according to the present invention. It illustrates how the system interacts with the world. It shows numerous data input sources and processes, the central database structure, some internal processing categories, and numerous output categories. Different sets of transactions are used by publishers and users.

Input. FIG. 1 shows that there are two illustrative examples of sources for lineage-linked data: Home PC Data 12 and Internet Data 14. FIG. 1 also shows that there are three illustrative examples of types of input from the user: written 16, still images 18, and, video images 16.

The Data Monitoring and Censoring Workstation. The Data Monitoring and Censoring Workstation 24 contains an interface that allows for monitoring and censoring via deletion of inappropriate data submissions according to predetermined parameters. These parameters may include but are not limited to slanderous, false scandalous or pornographic materials. All of these functions can go on in the central Internet site, but central site performance will be improved by executing these specialized and computer-intensive operations on separate computers where possible.

Internal and Maintenance Programs and Processes. Some of the programs, called the manual keying interface 28, allow manual updates to the data and links after they have been added to the main database. Programs referred to as central database maintenance and librarian functions 30 handle general administrative functions such as devising formats for entering new types of source reference data.

Output. Still referring to FIG. 1, the area 38 below the main database shows the main outputs of the system. The normal text and graphics interface 40 uses a program 42 to display data submitted on individuals.

Main Database. The central server database 20 is also represented in FIG. 1. Two or more sections 50, 52 (labeled “Publisher Submission—Basic Data on Individuals”) provide space to store the main tables of information about individuals.

Main Database Data Types. There are many other kinds of data that must be stored in the database. The data types listed below generally do not correspond to actual database tables in the database. Each category may represent several physical tables or only a part of one or more tables. Publisher Submission—Basic Data on Individuals 50, 52 store individual names in large numbers. The Publisher Submission—Basic Data allows any interested party to add information regarding a specific individual. Publisher Submissions 60 is for storing a variety of information on individual stored in the central server database, such as source references, biography, photos, source record images, audio and video clips. Data assignments help coordinate efficient database construction. Submission Lineage-Linking Space 56 represents storage of the submission internal name-linking records.

The thousands of the people using the site will be able to prepare data on individuals to be transferred to the Internet site to be “published,” as that term is used herein. A much larger number of people called “users” or “searchers” herein, will search through the central site for data that relate to individuals. The “Authors”—i.e persons who submit or publish data can edit or delete information contained in their submissions.

The searchers are mostly people with an interest in one or more individual's contained in the database. The publishers include persons with knowledge concerning one or more individuals in the database.

Operation of the System

The main functions of the system of the present invention are to (1) collect from publishers information on individuals with regard to personality traits, habits, physical and psychological characteristics. Data interfaces will include the normal text as well as still and moving images in a Graphic User Interface, plus a Virtual Reality version as well.

Collecting Data—Main Source. The main source of quality data is from publishers who have personal or other first hand knowledge of an individual or individuals listed on the site. Data from publishers possessing significant data can be sent in directly from a home PC after automated conversion from a GEDCOM file. It can also be entered directly into the central database by keying data into the “express” or short-form screens or by keying it into the full data screens. It can also be mailed or sent by file transfer to a central processing site.

Collecting Data—Other Options. Smaller linked GEDCOM files can be collected into one central location where a special data consolidation workstation can help to match and join that information into much larger collections. These data might be chosen from among the data collections already on the Internet.

Optional Display of Data Through Virtual Reality Interface. The Virtual Reality interface allows a user to view large amounts of data regarding an individual in a virtual reality and/or 3-D network form. The virtual reality feature uses the same data as the normal interface, and the overwhelming thrust and priority of this effort is to get the data into the best possible format and condition. In the virtual reality presentation, the data will be presented in the form of an avatar with whom the user can interact in a virtual reality environment via the user's avatar. User can also use the personality data of an individual in constructing an avatar used for role playing. Such use of an interactive virtual environment world that incorporates real life characteristics of actual people could serve a very useful educational benefit. As an alternative, the avatar can be a virtual reality representation of an individual in the database, whose physical, psychological, and behavioral characteristics are generated by the computer based on the information contained in the databese.

Data Improvement and Database Maintenance Operations. Besides the main process of entering of new data, there will be thousands of participants locating and linking information to particular names. It will also be necessary to have a few skilled operators using specialized transactions to monitor operations and occasionally censor or remove data according to certain preexisting parameters. The database may have the ability to differentiate and cross reference individual information via identifiers such as birth date or birth year. The database may also be integrated with other dating databases and contain a program to allow the name, pseudonym and other data regarding an individual can be cross referenced with the name, pseudonym and other data regarding that same individual contained in the dating database.

Central Server Main Relational Database Structure and Use

The design for the central database is extremely important to allow for all the needed functions to go on simultaneously. The publishers, i.e., the people who submit information into the system, will each be assigned a block of numbers as the place to enter their data.

The main table in the database is called Person_T. It contains the identifying name and other identifying characteristics regarding the person whose information is being submitted such as basic identifying data such as birth date, height, eye color weight etc.

Other tables containing data about the person are Text_T to hold textual biographical data, Photo_T which holds references to photo images stored about that person, and Image_T to hold references to images of source records stored about that person. Other similar tables can be added as other data types are added, such as audio or video clips.

Interactive Interface. This feature has been briefly described above. This feature allows the user to interact with the web site by accessing chat rooms or anonymous private messaging, or other communication media in which particular listed individuals are the subject of conversation and wherein the user can interact and communicate with others who have personal knowledge or other information regarding that individual and can answer specific questions.

The subject matter claimed is:

1. A dynamic personal rating system for collecting, summarizing, indexing, linking and displaying various factual and opinion input and displaying the results on a computer comprising:
(a) a central server database comprising
(i) a plurality of contributors' data spaces for storing personality data in individual-identifier linked form,
(ii) a submission link space coupled to the plurality of contributors' data spaces for making and storing links between personality items in each of the plurality of contributors' data spaces, and
(iii) a third-party link space coupled to the plurality of contributors' data spaces for making and storing links between personality items between the plurality of contributors' data spaces;
(b) a normal text and graphics interface coupled to the central server database;
(c) a basic data display coupled to the normal text and graphics interface;
(d) a data status and management mechanism coupled to the normal text and graphics interface for monitoring quantity and quality of data;
(e) a manual keying interface coupled to the central server database for inputting and correction of data; and
(f) a data conversion and automated input coupled to the central server database for converting data into usable format and inputting large data files.

2. The genealogy registry system of claim 1 further comprising a plurality of interactive self-service internet terminals and central servers configured for accepting genealogical data from a plurality of publishers and displaying such genealogical data to a plurality of users.

3. The dynamic personal rating system of claim 1 wherein the system is configured for internet transactions to allow updates and review by a plurality of selected persons.

4. The dynamic personal rating system of claim 1 wherein the central server database comprises a structure for storing one or more data items selected from the group consisting of basic identifying data, explanatory text, biographical text, source references, photographs, images, video and moving images.

5. The dynamic personal rating system of claim 1 further comprising a program permitting both minimal data display and update and full detail data display and update.

6. The genealogy registry system of claim 1 further comprising a program and data structure configured for storing age, height, weight, hair color, eye color and other physical identifying characteristics.

7. The dynamic personal rating system of claim 1 further comprising a mechanism for permanent storage of assembled data.

8. The dynamic personal rating system of claim 1 further comprising a program and data structure for storing and processing data in a plurality of languages using the language and characters of original records with transliteration and translation to English.

9. The dynamic personal rating system of claim 1 further comprising a program and data structure for reserving and assigning to a single publisher creation and maintenance of a selected set of names based on at least one of time, place, surname, or record set, and indexes to such assigning for notifying others of current assignments.

10. The dynamic personal rating system of claim 1 further comprising a program and data structure configured for permitting data submissions by a publisher to be stored independent of submissions by other publishers while being available for integration with other data submissions through a separate system of linking names that is accessible to such other publishers.

11. The dynamic personal rating system of claim 1 further comprising a program and data structure for allowing a selected person to link names within or between one or more other publisher's submissions without changing the underlying data.

12. The dynamic personal rating system of claim 1 further comprising a program and data structure configured for permitting an authorized person to create shadow delete records wherein duplicate names can be removed from search lists and duplicate data can be hidden from users without being deleted from the database.

13. The dynamic personal rating system of claim 1 further comprising an interface with a censor that reviews and screens the data submissions based on preexisting criteria.

14. The dynamic personal rating system of claim 1 further comprising a program for displaying all relationships for a selected person.

15. The dynamic personal rating system of claim 1 further comprising a read-only virtual reality user interface configured for permitting a user or group of users to receive immediate visual and aural access to the data in the database, wherein the data appear as objects in a three-dimensional world with which the user can interact.

16. The dynamic personal rating system of claim 1 further comprising a virtual reality user interface configured for permitting a user or group of users to receive immediate visual and aural access to the data in the database, wherein the data appear as objects in a three-dimensional world with which the user can interact, and whereby an authorized user can modify the database.

17. The dynamic personal rating system of claim 1 further comprising a mechanism configured for allowing a publisher or other authorized person to examine the database for assessing appropriateness of submission to the database.

18. The dynamic personal rating system of claim 17 further comprising second-level cross references between source records and names such that measures of accuracy and duplication can be applied to the data, and measures of completeness of coverage of a record set can be estimated, and cross indexing can be accomplished between multiple versions or copies of the same record set.

19. The dynamic personal rating system of claim 18 further comprising third-level cross references of source-to-dissimilar-source records such that the database can supply consolidated cross reference indexes among multiple record sources linked through specific people.

20. The dynamic personal rating system of claim 1 further comprising a program for automatic conversion of a user's individual identifier-linked personality data into a format suitable for automatic update of the database over the Internet.

21. The dynamic personal rating system of claim 1 further comprising a program and data structure configured for capturing, converting, and consolidating individual identifier-linked personality data collections stored for public view on the Internet.

22. A dynamic personal rating system for collecting, summarizing, indexing, linking and displaying various factual and opinion input and displaying the results on a computer comprising:
(a) a central server database comprising
(i) a plurality of contributors' data spaces for storing personality data in individual-identifier linked form,
(ii) a submission link space coupled to the plurality of contributors' data spaces for making and storing links between personality items in each of the plurality of contributors' data spaces, and
(iii) a third-party link space coupled to the plurality of contributors' data spaces for making and storing links between personality items between the plurality of contributors' data spaces;
(b) a normal text and graphics interface coupled to the central server database;
(c) a basic data display coupled to the normal text and graphics interface;
(d) a data status and management mechanism coupled to the normal text and graphics interface for monitoring quantity and quality of data;
(e) a manual keying interface coupled to the central server database for inputting and correction of data; and
(f) a data conversion and automated input coupled to the central server database for converting data into usable format and inputting large data files.
